(19) United States
(12) Patent Application Publication
(10) Pub. No.: US 2016/0230969 A1
(43) Pub. Date: Aug. 11, 2016

(54) RECESSED LIGHT FIXTURE

(71) Applicant: Eclairage Contraste M.L. Inc., Saint-Jean-Chrysostome (CA)

(72) Inventors: Marc Pelletier, Saint-Jean-Chrysostome (CA); Patrice Beaudet, Ste-Marie De Beauce (CA); Steve Bilodeau, Saint-Jean-Chrysostome (CA)

(21) Appl. No.: 14/616,384

(22) Filed: Feb. 6, 2015

(51) Int. Cl. F21V 21/04; F21V 21/26; F21V 19/00; F21V 23/00

(52) U.S. Cl. CPC F21V 21/048; F21V 23/008; F21V 21/26; F21V 23/002; F21V 19/007

(57) ABSTRACT

A recessed light fixture, comprising a housing; a junction box; and a flexible arm connecting said housing and the junction box together; wherein the flexible arm comprises a plate extending between the junction box and the housing and supporting a cover, the cover comprising at least one flexion line across a width thereof between the housing and the junction box.

### FIELD OF THE INVENTION

The present invention relates to recessed light fixture. More specifically, the present invention is concerned recessed light fixture comprising a housing and a junction box connected by a flexible arm.

### BACKGROUND OF THE INVENTION

Recessed light fixtures are typically mounted between ceiling joists or suspended ceiling support members. They may be installed in new constructions, i.e. when the ceiling joists are still exposed, or in existing buildings, i.e. when the ceiling is already finished with drywall or plaster and lath.

Light fixtures for installation in existing buildings typically comprise a housing and a junction box connected by a flexible wire. For installation, the user cuts an opening in the ceiling, inserts the fixture within the opening in the ceiling from below and locks it into position by mounting clips provided on the housing.

There is still a need in the art for a recessed light fixture.

### SUMMARY OF THE INVENTION

More specifically, in accordance with the present invention, there is provided a recessed light fixture, comprising a housing; a junction box; and a flexible arm connecting said housing and the junction box together; wherein the flexible arm comprises a plate extending between the junction box and the housing and supporting a cover, the cover comprising at least one flexion line across a width thereof between the housing and the junction box.

There is further provided a junction box for a recessed light fixture, wherein one of: i) a top and ii) a side wall of the junction box extends into a plate secured on a free end thereof to a housing of the recessed light fixture, the plate supporting a cover, and the cover comprising at least one flexion line across a width thereof between the housing and the junction box.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1A shows a perspective view of a recessed light fixture assembly according to an embodiment of an aspect of the present invention;

FIG. 1B is a top view of the assembly of FIG. 1A;

FIG. 1C is a side view of the assembly of FIG. 1A;

FIG. 2 shows details of a housing and a junction box of a light fixture assembly according to an embodiment of an aspect of the present invention;

FIG. 3A shows a light fixture assembly according to an embodiment of an aspect of the present invention in a straight configuration;

FIG. 3B shows a light fixture assembly according to an embodiment of an aspect of the present invention in a bent down configuration;

FIG. 3C shows a light fixture assembly according to an embodiment of an aspect of the present invention in a bent up configuration;

FIG. 4A shows a cover of an arm according to an embodiment of an aspect of the present invention;

FIG. 4B shows an arm according to an embodiment of an aspect of the present invention;

FIG. 5A shows a first configuration of a light fixture assembly according to an embodiment of an aspect of the present invention;

FIG. 5B shows a second configuration of a light fixture assembly according to an embodiment of an aspect of the present invention;

FIG. 6A shows a perspective top view of a recessed light fixture assembly according to an embodiment of an aspect of the present invention;

FIG. 6B shows a top view of the assembly of FIG. 6A;

FIG. 6C shows a side view of the assembly of FIG. 6A;

FIG. 6D shows a bottom view of the assembly of FIG. 6A;

FIG. 6E shows a perspective bottom view of the assembly of FIG. 6A;

FIG. 7 shows steps of installation of a light fixture assembly according to an embodiment of an aspect of the present invention;

FIG. 8 shows steps of installation of a light fixture assembly according to an embodiment of an aspect of the present invention; and

FIG. 9 shows steps of installation of a light fixture assembly according to an embodiment of an aspect of the present invention.

### DESCRIPTION OF EMBODIMENTS OF THE INVENTION

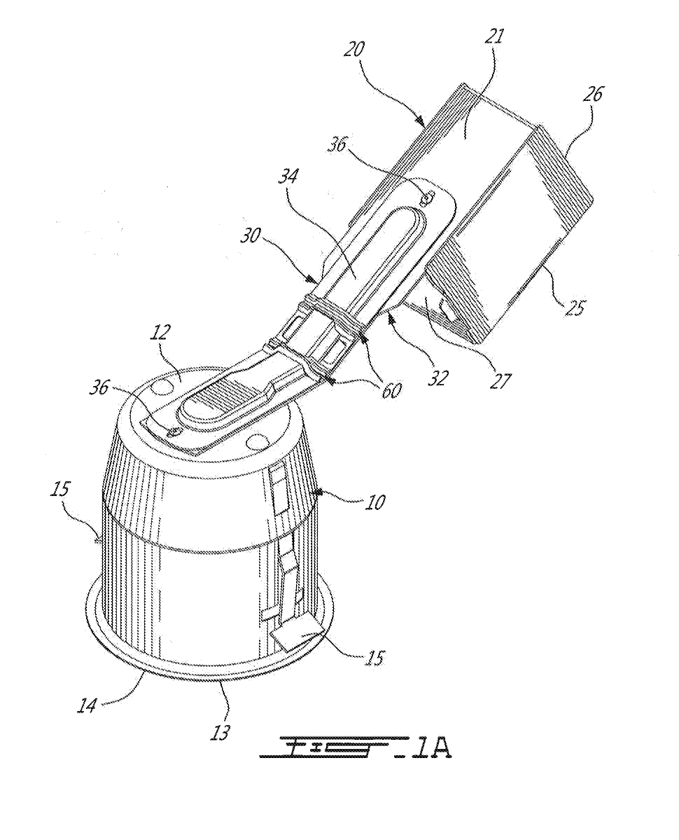

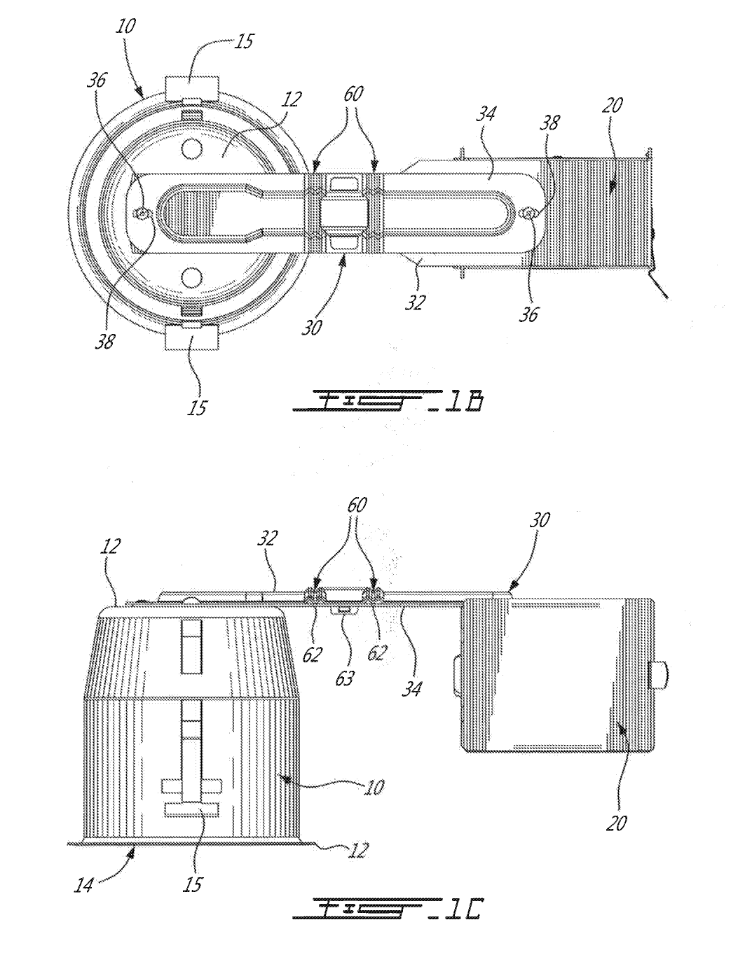

As generally illustrated in FIG. 1, the recessed light fixture comprises a housing 10 and a junction box 20 connected together by an arm 30.

The housing 10 typically comprises a top wall 12 and a bottom open end terminating in a flange 13. The housing 10 comprises at least one retaining member 15 for securing the housing 10 in a ceiling location The housing 10 generally supports a light source, a reflector, a lens, a cooling member lamp socket as known in the art.

The junction box 20 comprises a top wall 21, bottom wall 25, side walls 26, 27 and generally defines an enclosure for connecting wires (not shown) from an electrical power source to the lamp socket in the housing 10.

As illustrated in the figures, the arm 30 extends from the top wall 12 of the housing 10 to the top wall 21 of the junction box 20. Alternatively, the arm 30 may connect the housing 10 to the junction box 20 through respective lateral walls thereof (not shown).

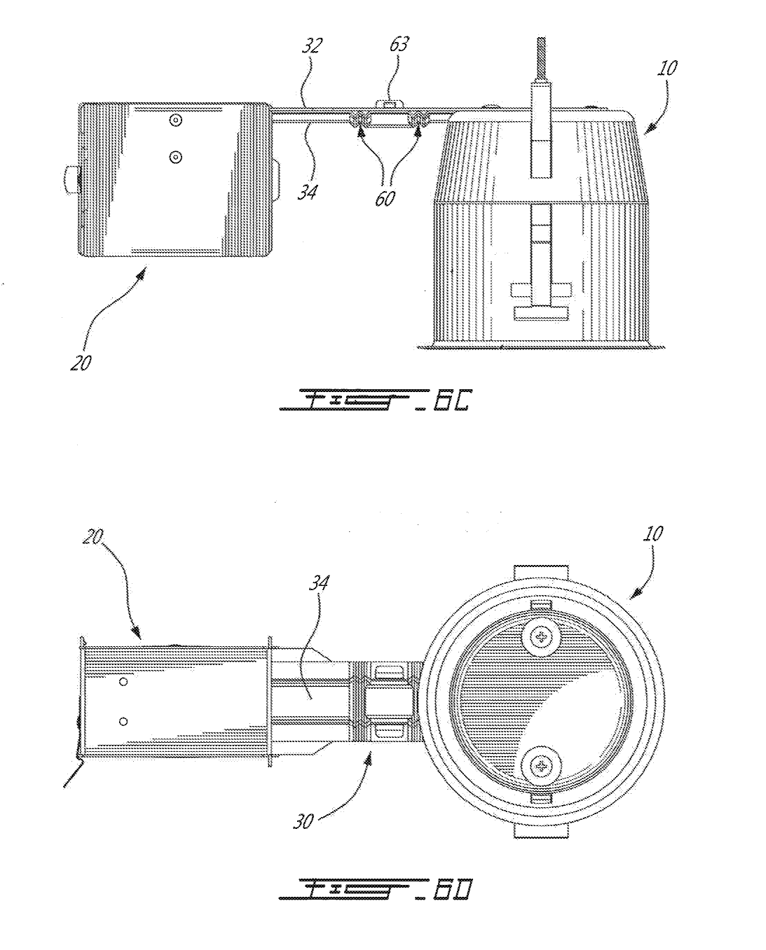

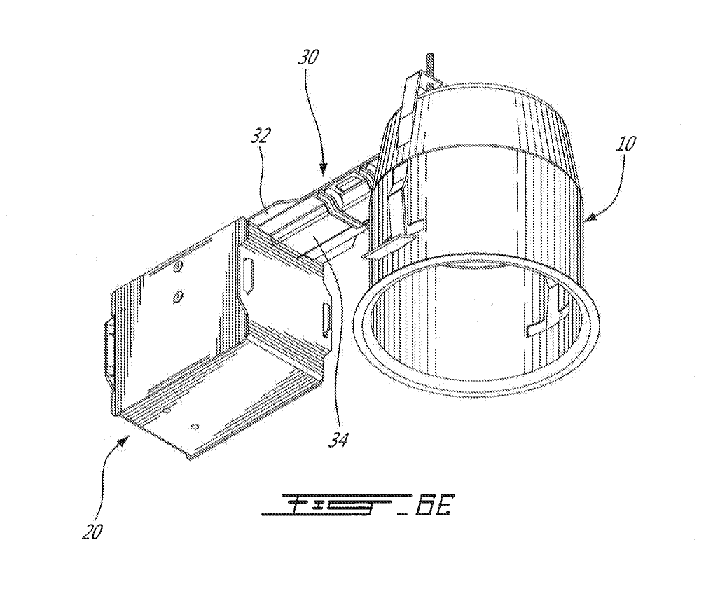

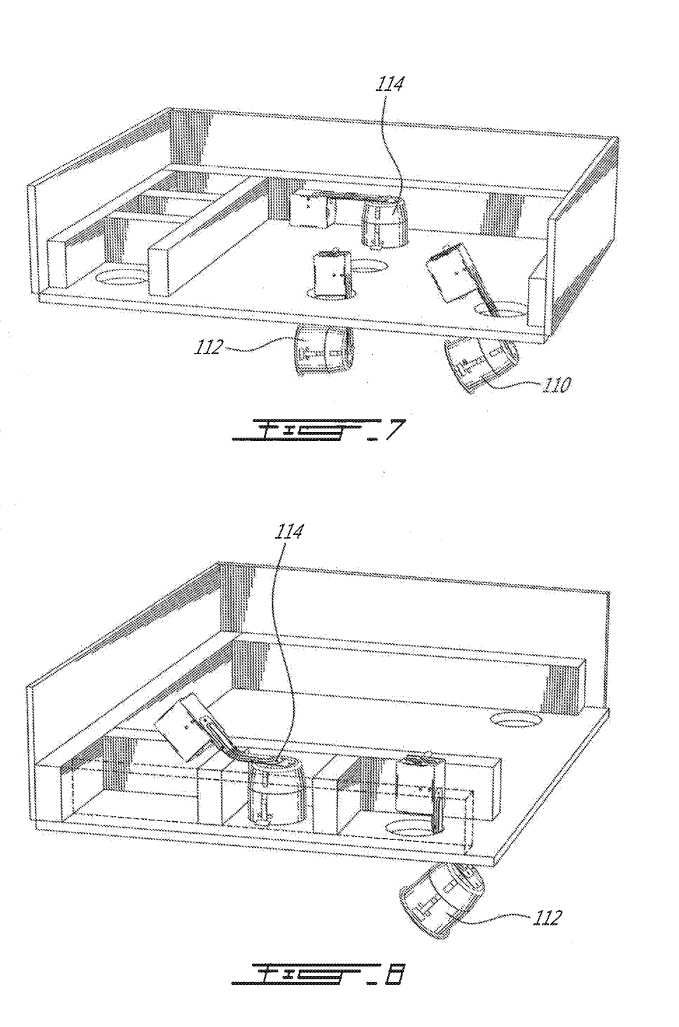

The arm 30 comprises a plate 32 and a cover 34. The plate 32 may be an extension of the top wall 21 of the junction box 20, the top wall 21 of the junction box 20 narrowing down into a plate 32 of a reduced width as shown in FIGS. 1a and 1b for example, and secured to the top wall 12 of the housing 10 on the opposite end using rivets 37 as seen in FIG. 6 for example, or using screws, welding, or snaps.

For securing the cover 34 on the plate 32 on each end thereof, snaps, screws, welding or rivets 36 through openings 38 as illustrated in the figures (see for example FIGS. 1a and b) may be used. The arm 30 thus formed runs from the top wall 12 of the housing 10 to the top wall 21 of the junction box 20 covering respective openings in the top walls 12, 21 thereof, and houses wires running from the housing 10 to the junction box 20. Although the cover 34 was described hereinabove as secured on the upper surface of the plate 32, it may be secured on the lower surface of the plate 32 as illustrated for example in FIG. 6. Both the plate 32 and the cover 34 are made in a rigid material, such as stainless steel, plastic, aluminum or alloy for example.

The material and the thickness of the cover 34 are selected so that flexion lines 60 extending transversally can be provided across a width of the cover 34, such as embossed lines or lines of a reduced thickness compared to the nominal thickness of the remaining of the cover 34, allowing repeated flexion of the cover about this at least one embossed line without risking tearing.

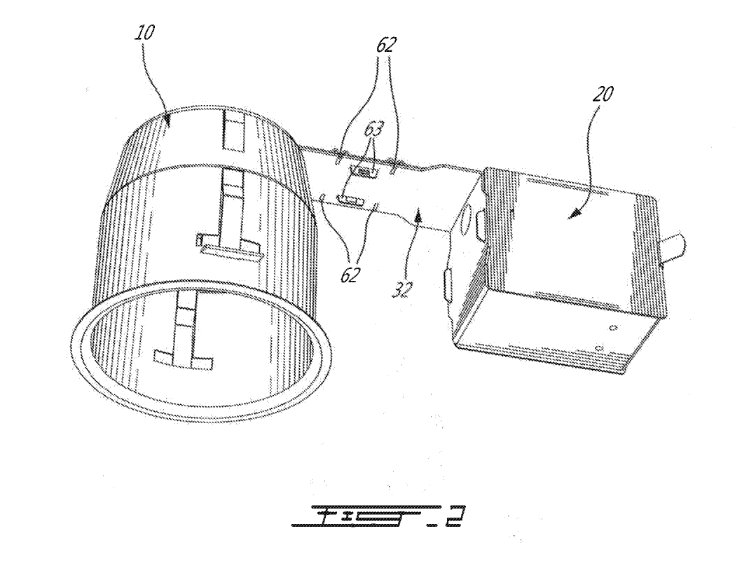

At locations generally facing or opposite these lines 60 on the cover 34, the material of the plate 32 may be provided with a flexion area, such as lines 62 of a reduced thickness forming a transverse zone of a reduced thickness compared to the nominal thickness of the remaining of the plate 32 as seen in FIG. 1c, or with precut edge lines 62 as shown in FIGS. 2 and 6A, 6B for example. Alternatively, the material of the plate 32 may be selected so as to be rigid and sufficiently flexible so as to be able to follow the flexion of the cover 34 if needed.

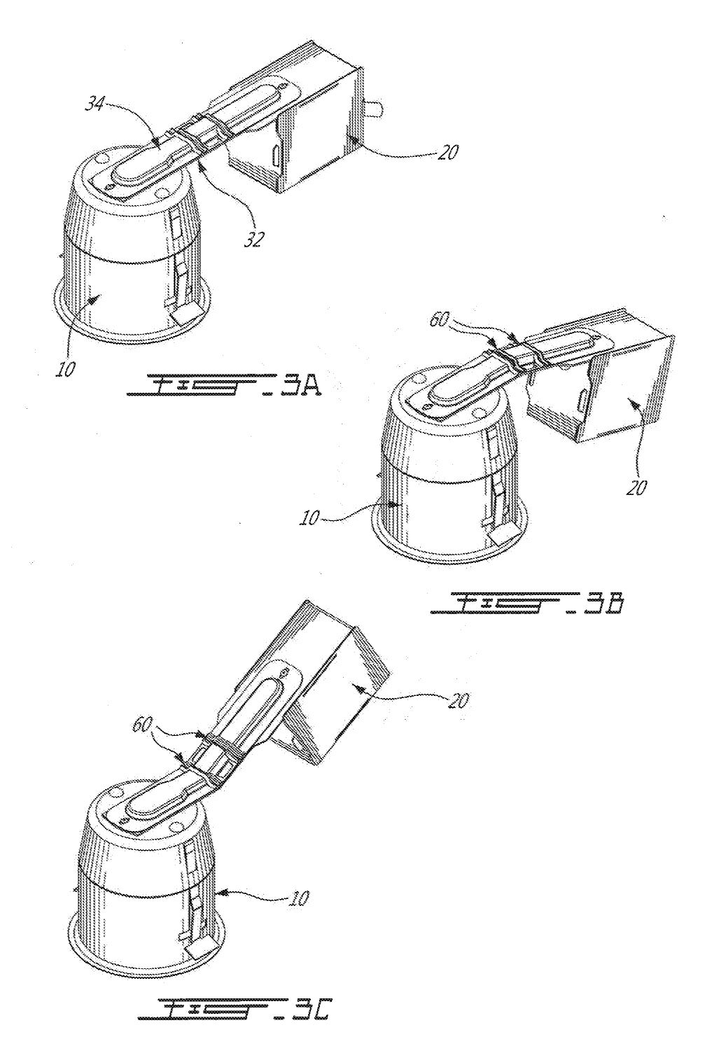

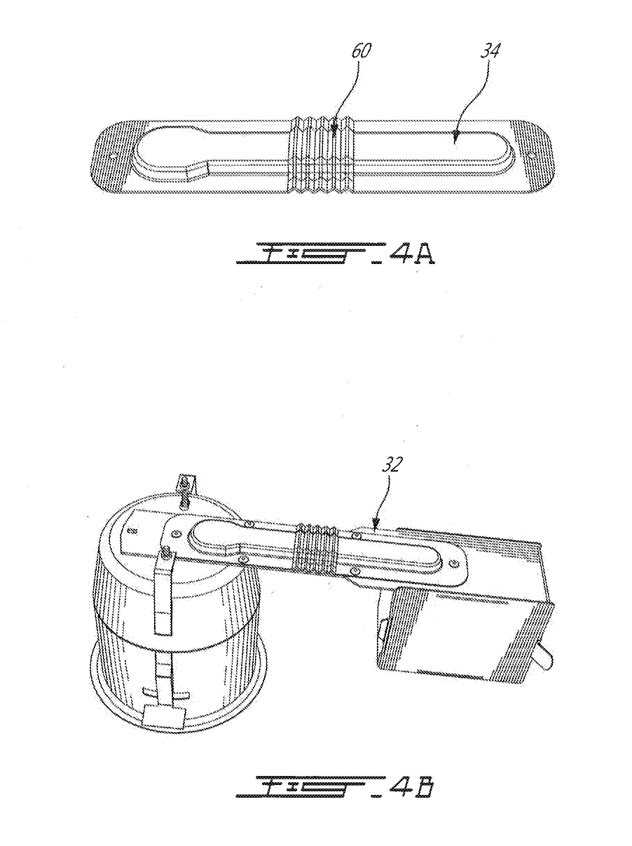

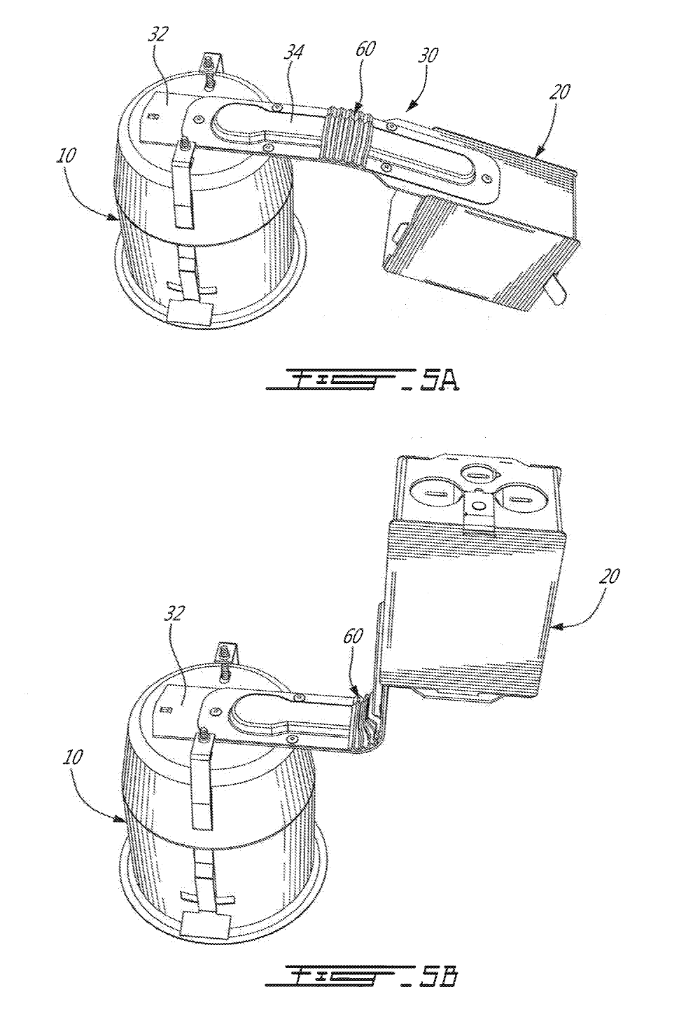

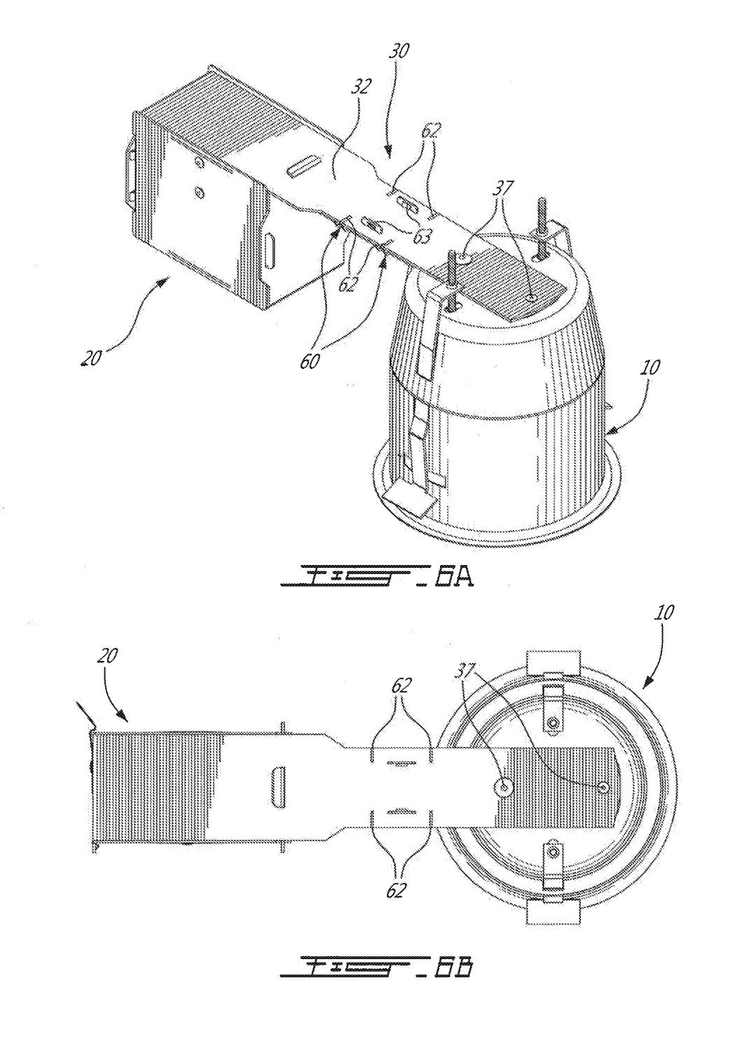

As a result, the arm is flexible from a straight position between the housing 10 and the junction box 20 (FIG. 3A) to positions where the arm is bent so that the junction box 20 and the housing 10 are maintained at an angle one relative to the other, i.e. the top wall of the housing 10 is positioned below the top wall of the junction box 20 (FIG. 3C) or above the top wall of the junction box 20 (not shown), or at an angle with the top wall of the junction box 20 (FIG. 3B).

Besides fastening means generally at ends thereof, i.e. at the housing 10 (see rivets 37 In FIG. 6 for example) and at the junction box (see rivet 36 in FIG. 1 for example), the cover 34 and the plate 32 are secured together in the deformation area of the arm 30 formed by the lines 60 and 62 of the cover 34 and of the plate 32 respectively, for example by a retaining clip 63 as shown in FIGS. 1 and 6, or by a rivet, welding or a snap for example. Thus the cover 34 is prevented from peeling away from the plate 32 upon bending of the arm 30.

The height of the cover 34 relative to the plate 32 is selected so as to accommodate wires therethrough without pinching or otherwise damaging the wires upon bending of the arm 30.

Provision of oblong openings 38 for connexion between the cover 34 and the plate 32 by rivets 36 as illustrated for example allows accommodating movements of the cover 34 between different positions of the arm 30 as shown in FIG. 3.

The present arm allows rigidly holding the housing and the junction box at different relative positions as shown in FIG. 3.

The different embodiments described hereinabove are given as way of examples only and respective features may be used alone or in combination.

A recessed light fixture assembly comprising an arm as described herein may achieve airtightness below 2 cubic feet per meter.

For installation, a user cuts an opening in the ceiling, inserts the fixture within the opening in the ceiling from below and locks it into position by mounting clips provided on the housing.

FIG. 7 illustrates inserting the junction box first (112), then the housing (114) through such an opening in the ceiling so as to position the assembly (114).

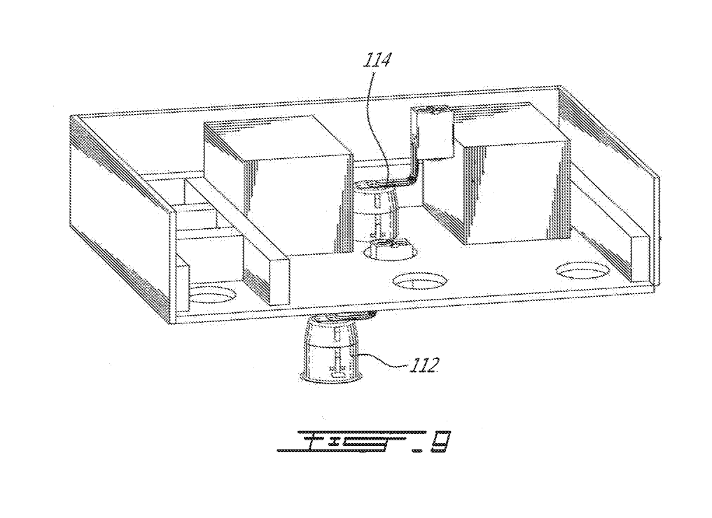

In case of ceiling configurations where space is limited, flexibility of the arm is necessary for insertion of the junction box and the housing to position the assembly, as illustrated for example in FIGS. 8 and 9.

The present assembly comprises an arm rigidly connecting the housing to the junction box while allowing flexibility for ease of installation of the assembly when necessary, for example to facilitate the passage of the housing in the ceiling where space is limited, while fully enclosing and sheltering electric wires within the assembly.

The scope of the claims should not be limited by the embodiments set forth in the examples, but should be given the broadest interpretation consistent with the description as a whole.

1. A recessed light fixture, comprising:
a housing;
a junction box; and
a flexible arm connecting said housing and said junction box together;
wherein said flexible arm comprises a plate extending between said junction box and said housing and supporting a cover, said cover comprising at least one flexion line across a width thereof between said housing and said junction box.

2. The recessed light fixture of claim 1, wherein said plate is made in a rigid material, and said plate comprises a flexion area at a location generally facing said flexion line of said cover.

3. The recessed light fixture of claim 1, wherein said plate is made in a rigid material, said cover is made in a rigid material, and said plate comprises a flexion area at a location generally facing said flexion line of said cover.

4. The recessed light fixture of claim 1, wherein said plate is made in a rigid material of a nominal thickness, said plate comprises at least one of: i) a transverse zone of a reduced thickness compared to said nominal thickness and ii) precut edge lines generally opposite said flexion line.

5. The recessed light fixture of claim 1, wherein said cover is made in a rigid material, and said flexion line is an embossed line extending transversally across a width of the cover.

6. The recessed light fixture of claim 1, wherein said cover is made in a rigid material of a nominal thickness, and said flexion line is a line of a reduced thickness compared to said nominal thickness and extending transversally across a width of the cover.

7. The recessed light fixture of claim 1, wherein said plate is made in a rigid material of a nominal thickness, said flexion line is an embossed line extending transversally across a width of the cover, and said plate comprises at least one of: i) a transverse zone of a reduced thickness compared to said nominal thickness and ii) precut edge lines generally opposite said embossed line.

8. The recessed light fixture of claim 1, wherein said plate is made in a rigid material of a first nominal thickness, said cover is made in a rigid material of a second nominal thickness, said flexion line is a line of a reduced thickness compared to said second nominal thickness and extending transversally across a width of the cover, and said plate comprises at least one of: i) a transverse zone of a reduced thickness compared to said first nominal thickness and ii) precut edge lines generally opposite said embossed line.

9. The recessed light fixture of claim 1, wherein wires run within said arm between said housing and said junction box.

10. The recessed light fixture of claim 1, wherein said arm extends from a top wall of the housing to a top wall of the junction box.

11. The recessed light fixture of claim 1, wherein said plate is an extension of a top wall of said junction box, and said plate supports said cover on one of: i) an upper surface and ii) a lower surface thereof.

12. The recessed light fixture of claim 1, wherein said arm is secured to the housing by one of: rivets, screws, welding and snaps.

13. The recessed light fixture of claim 1, wherein said cover is secured to said plate by one of: rivets, screws, welding and snaps.

14. The recessed light fixture of claim 1, wherein said cover is secured to said plate at ends thereof and at the location of the flexion line of the cover.
